(19) United States
(12) Patent Application Publication
(10) Pub. No.: US 2012/0327447 A1
(43) Pub. Date: Dec. 27, 2012

(54) IMAGE FORMING APPARATUS

(75) Inventor: Hisataka FUNAKAWA, Toyokawa-shi (JP)

(73) Assignee: Konica Minolta Business Technologies, Inc., Chiyoda-ku (JP)

(21) Appl. No.: 13/529,340

(22) Filed: Jun. 21, 2012

(30) Foreign Application Priority Data
Jun. 24, 2011 (JP) 2011-140734

(51) Int. Cl. G06F 3/044; G06K 15/02

(52) U.S. Cl. 358/1.13

(57) ABSTRACT

An image forming apparatus operates in modes including a normal mode and a power saving mode less in power consumption than the normal mode. The image forming apparatus includes an operation unit for receiving an instruction from a user. The operation unit has an operation region into which a prescribed instruction from the user is input. The image forming apparatus includes a first detection unit disposed corresponding to the operation region for detecting an input into the operation region from the user in the normal mode, and a second detection unit for detecting a human body located near the operation region in the power saving mode. The second detection unit is disposed on a substrate on which the first detection unit is disposed.

This application is based on Japanese Patent Application No. 2011-140734 filed with the Japan Patent Office on Jun. 24, 2011, the entire content of which is hereby incorporated by reference.

### BACKGROUND OF THE INVENTION

1. Field of the Invention

The present invention relates to an image forming apparatus controlling shifting of its operation mode to a power saving mode.

2. Description of the Related Art

Conventionally, for the purpose of reducing power consumption, when an image forming apparatus is not used for a certain period of time, power control is performed to shift the operation mode to a low power consumption mode to stop power supply to some parts of this image forming apparatus. In the low power consumption mode, when the operation panel of this apparatus receives the operation from the user, the low power consumption mode is canceled and shifted to a normal mode. This shift operation is performed by continuously scanning the keys and the touch panel on the operation panel by a detection circuit disposed inside the operation panel and detecting the operation from the user. In recent years, however, in order to further reduce power consumption in the low power consumption mode, power supply to the above-described detection unit is also stopped. In this case, since the user cannot cancel the low power consumption mode through the operation on the operation panel, it is proposed to separately provide a human body detection sensor to cancel the power saving mode based on the detection results by this human body detection sensor.

For example, Japanese Laid-Open Patent Publication No. 2006-251194 proposes to provide a mat switch on the floor surface in front of the image forming apparatus to detect that the user stands in front of the apparatus, thereby cancelling the power saving mode.

According to the technique disclosed in Japanese Laid-Open Patent Publication No. 2006-251194, however, although the power saving mode can be cancelled based on whether or not the user stands in front of the image forming apparatus, the power saving mode cannot be cancelled based on whether or not the user operates the image forming apparatus. In this case, in order to detect the operation from the user, it is also proposed to provide a human body detection sensor near the region where the user operates the apparatus. However, production of a substrate and the like dedicated to this detection sensor also causes problems of an increase in cost and an increase in size of the apparatus.

### SUMMARY OF THE INVENTION

The present invention has been made to solve the above-described problems. An object of the present invention is to provide an image forming apparatus that can be reduced in size and is capable of detecting a user in accordance with the user's usage manner.

According to an aspect of the present invention, an image forming apparatus operates in modes including a normal mode and a power saving mode less in power consumption than the normal mode. The image forming apparatus includes an operation unit for receiving an instruction from a user. The operation unit has an operation region into which a prescribed instruction from the user is input. The image forming apparatus includes a first detection unit disposed corresponding to the operation region for detecting an input from the user into the operation region in the normal mode, and a second detection unit for detecting a human body located near the operation region in the power saving mode. The second detection unit is disposed on a substrate on which the first detection unit is disposed.

Preferably, the second detection unit includes an antenna unit for detecting a change in capacitance of an electrode caused by approach of an object. The antenna unit is disposed on the substrate on which the first detection unit is disposed.

Preferably, the antenna unit is disposed along an outer periphery of the substrate.

Preferably, the image forming apparatus further includes a power supply control unit for supplying electric power to the second detection unit but not to the first detection unit in the power saving mode.

Preferably, a detection region in the second detection unit is defined in a range including the operation region.

Preferably, the second detection unit detects the human body by detecting a change in capacitance between a detection electrode and the human body.

As described above, according to the present invention, the user can be detected in accordance with the user's usage manner while the apparatus can be reduced in size.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic front cross-sectional view showing an image forming apparatus according to the present embodiment.

FIG. 2 is a block diagram showing the hardware configuration of the image forming apparatus according to the present embodiment.

FIG. 3 is a diagram showing an example of the external appearance of an operation panel according to the present embodiment.

FIG. 4 is a schematic diagram showing the configuration of a touch panel attached to a display of the operation panel according to the present embodiment.

FIG. 5 is a diagram showing an example of the schematic configuration of a detection unit corresponding to operation keys on the operation panel according to the present embodiment.

FIG. 6 is a diagram showing the details of power control in each of the normal mode and the power saving mode in the operation panel according to the present embodiment.

FIG. 7 is a flowchart illustrating the processing procedure of shifting the operation mode of the image forming apparatus according to the present embodiment.

FIG. 8 is a schematic explanatory diagram of the configuration of a human detection sensor according to the present embodiment.

FIG. 9 is a diagram showing an example of the arrangement position of an antenna corresponding to the human detection sensor according to the present embodiment.

FIG. 10 is a diagram showing the positional relationship of the antenna with a detection unit of the operation keys and the touch panel disposed on a printed circuit board in the operation panel according to the present embodiment.

FIG. 11 is a schematic cross-sectional view of the operation panel taken along a line A-A′ in FIGS. 9 and 10.

FIG. 12 is a schematic cross-sectional view of the operation panel taken along a line B-B′ in FIGS. 9 and 10.

### DESCRIPTION OF THE PREFERRED EMBODIMENTS

The present embodiments will be hereinafter described with reference to the accompanying drawings. In the following description, the same components are designated by the same reference characters. Names and functions thereof are also the same. Therefore, detailed description thereof will not be repeated.

<Entire Configuration>

First, the entire configuration of an image forming apparatus according to the present embodiment will be hereinafter described. The image forming apparatus serves as a digital multi-functional peripheral, for example, having a document conveying function for sequentially conveying a plurality of documents, a re-conveying function for automatically making a double-sided copy, and the like.

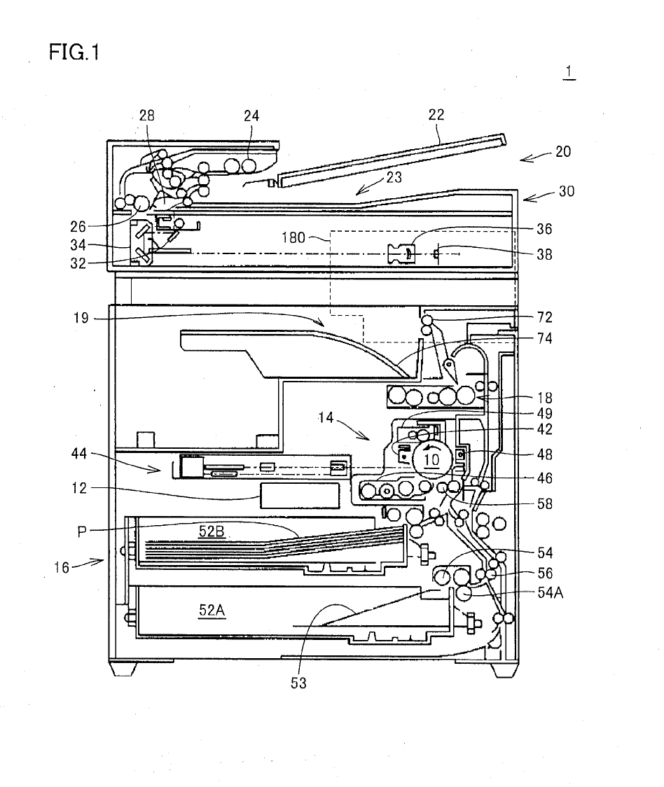

An image forming apparatus 1 according to the present embodiment will be hereinafter described with reference to FIG. 1.

Referring to FIG. 1, image forming apparatus 1 includes an image processing unit 12, an image forming unit 14, a paper feeding unit 16, a fixing device 18, and a paper discharge unit 19. Image forming apparatus 1 is provided in the upper portion of its body with an automatic document feeder 20 and an image reading unit 30.

Automatic document feeder 20 includes a document platen 22, an automatic feeding unit 23, and a feeding roller 24. On document platen 22 of automatic document feeder 20, a document (not shown) is placed such that its surface to be copied faces upward. Feeding roller 24 sequentially feeds documents to a conveying path, to convey these documents to automatic feeding unit 23.

A resist roller 26 serving as a skew correction unit is disposed at the end edge of the conveying path. Resist roller 26 rotates in synchronization with the scanning timing of image reading unit 30, to cause the document to pass above a slit glass 28.

Image reading unit 30 includes a first scanning unit 32, a second scanning unit 34, an imaging lens 36, and an image pickup element 38 such as a CCD (Charge Coupled Device). First scanning unit 32 includes a light source and a mirror for applying light to the document through slit glass 28. Second scanning unit 34 includes two mirrors guiding the reflected light to imaging lens 36.

When the document passes above slit glass 28 disposed in the upper portion of image reading unit 30, first scanning unit 32 applies light to the document to receive the light reflected from the document. The reflected light passes through second scanning unit 34 and imaging lens 36, and enters image pickup element 38. In other words, first scanning unit 32, second scanning unit 34 and imaging lens 36 form an image of the image printed on the document onto image pickup element 38, thereby reading the image printed on the document.

Image processing unit 12 generates image data based on an electrical signal from image pickup element 38. Specifically, image processing unit 12 performs image processing based on the electrical signal from image pickup element 38. More specifically, image processing unit 12 generates image data (digital data) showing an image based on the electrical signal (analog signal) from image pickup element 38, and temporarily stores this image data in a memory 110 described later.

Image forming unit 14 includes an image carrier 10, a charging device 42, an image writing unit 44, a developing device 46, and a transferring device 48. Charging device 42 is disposed along the outer peripheral surface of image carrier 10. Image carrier 10 rotates along charging device 42, thereby causing charging device 42 to charge the surface of image carrier 10 almost uniformly, Image writing unit 44 forms an electrostatic latent image on the surface of image carrier 10. Developing device 46 develops this electrostatic latent image to form a toner image. Transferring device 48 transfers the toner image on the surface of image carrier 10 onto transfer paper P. A cleaning device 49 cleans the surface of image carrier 10 after the transferring process.

Paper feeding unit 16 includes a paper feeding cassette 52 (52A, 52B). Paper feeding cassette 52 houses transfer paper P. A movable plate 53 is disposed within paper feeding cassette 52. Movable plate 53 has a free end that is continuously biased in the upward direction by the biasing means such as a flat spring. Such a configuration causes transfer paper P located at the top of the plurality of sheets of transfer paper P placed on movable plate 53 to be brought into contact with a pickup roller 54.

Pickup roller 54 discharges transfer paper P in contact with pickup roller 54 from paper feeding cassette 52. A separation roller 54A separates a plurality of sheets of transfer paper P sheet by sheet. A plurality of intermediate rollers 56 guide and convey transfer paper P to lower resist roller 58. Lower resist roller 58 feeds transfer paper P into transferring device 48 in accordance with the feeding timing.

As described above, transferring device 48 transfers the toner image formed on image carrier 10 onto transfer paper P. Transfer paper P having the toner image transferred thereon is conveyed to fixing device 18. Fixing device 18 fixes the toner image onto transfer paper P. Then, a paper discharge roller 72 holds transfer paper P to discharge transfer paper P to the outside of image forming apparatus 1. In other words, transfer paper P having the image printed thereon is placed on a discharge platen 74.

Furthermore, an operation panel 300 disposed at the front side of image forming apparatus 1 receives various instructions to image forming apparatus 1 from the user.

<Hardware Configuration>

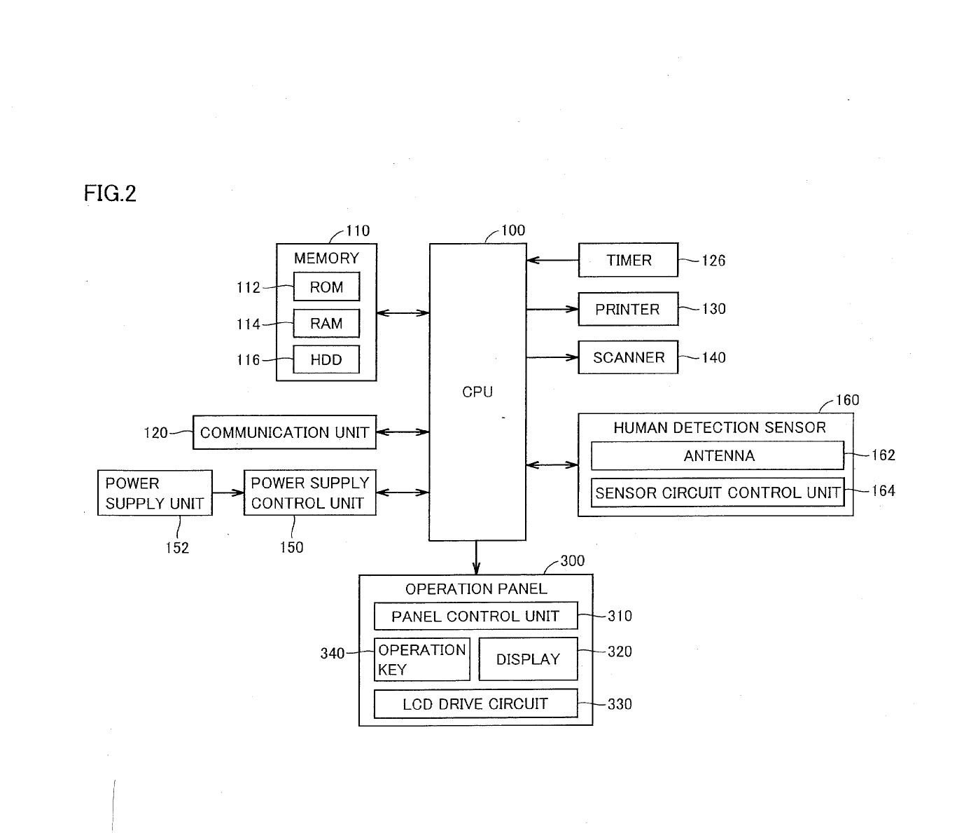

The hardware configuration of image forming apparatus 1 according to the present embodiment will be hereinafter described with reference to FIG. 2.

Referring to FIG. 2, image forming apparatus 1 includes a CPU (Central Processing Unit) 100, a memory 110, a communication unit 120, a timer 126, a printer 130, a scanner 140, a power supply control unit 150, a power supply unit 152, a human detection sensor 160, and an operation panel 300.

CPU 100 reads the program stored in advance in a non-volatile memory of memory 110 described later and sequentially executes the program, thereby controlling each unit of image forming apparatus 1. More specifically, CPU 100 executes the program to implement the process of image forming apparatus 1 described later.

Memory 110 is implemented by a non-volatile memory such as a ROM (Read Only Memory) 112, a RAM (Random Access Memory) 114, and an HDD (Hard Disk Drive) 116. ROM 112 stores the program executed by CPU 100 in advance while RAM 114 temporarily stores the data required for executing the program part of CPU 100. HDD 116 can store a relatively large capacity of data in a non-volatile manner. For example, HDD 116 stores a plurality of pieces of image data and the like obtained by scanner 140 described later reading the image.

Communication unit 120 is implemented by a network interface or the like. Communication unit 120 transmits and receives the image data to and from the personal computer or the server device through a network in accordance with a prescribed protocol. For example, communication unit 120 receives an authorized printing process requested from the user.

Timer 126, which clocks the time, transmits the signal in accordance with the clocked time to CPU 100. CPU 100 can perform a predetermined process based on this signal, for example, at constant time intervals.

Printer 130 prints an image on transfer paper P based on the image data. Printer 130 includes image processing unit 12, image forming unit 14, paper feeding unit 16, fixing device 18, and paper discharge unit 19 as main components.

Scanner 140 optically reads the document to obtain image data, and stores this image data in memory 110 as data. Scanner 140 includes image reading unit 30 as a main component.

In response to the instruction from CPU 100, power supply control unit 150 supplies the electric power from a power supply unit 152 to almost all units of image forming apparatus 1 (normal mode) or supplies the electric power only to some of the units of image forming apparatus 1 (power saving mode), thereby controlling power supply for image forming apparatus 1. For example, in the power saving mode, power supply control unit 150 stops power supply from power supply unit 152 to a panel control unit 310 described later, thereby decreasing power consumption.

Power supply unit 152, which has a circuit converting an alternating-current (AC) voltage into a direct-current (DC) voltage, causes image forming apparatus 1 to operate with the converted DC voltage.

Human detection sensor 160 is disposed in operation panel 300 described below and detects the existence of a human body in a prescribed detection region. For example, human detection sensor 160 is configured as a capacitance-type sensor and includes a detection electrode (antenna 162) and a sensor circuit control unit 164 which will be described later. Specifically, sensor circuit control unit 164 converts the change in the capacitance detected by antenna 162 into a detection signal and outputs the signal to CPU 100. In addition, when human detection sensor 160 detects a user in the power saving mode, CPU 100 cancels the power saving mode and causes image forming apparatus 1 to shift to the normal mode. Although human detection sensor 160 has been described in the present embodiment as a capacitance-type sensor by way of example, human detection sensor 160 is not limited to a capacitance-type sensor, but may be any type of sensor as long as it functions to detect a human body, and may be an infrared sensor, an ultrasonic sensor, and other human detection sensors.

Operation panel 300 includes a panel control unit 310, a display 320 which is a liquid crystal display, a LCD (Liquid Crystal Display) drive circuit 330, and operation keys 340 receiving the operation input from the user. It is to be noted that display 320 may be, for example, an organic EL (Electro-Luminescence) display while LCD drive circuit 330 may be an organic EL display drive circuit. It is to be noted that human detection sensor 160 is disposed at a prescribed position in operation panel 300, as will be described later in detail.

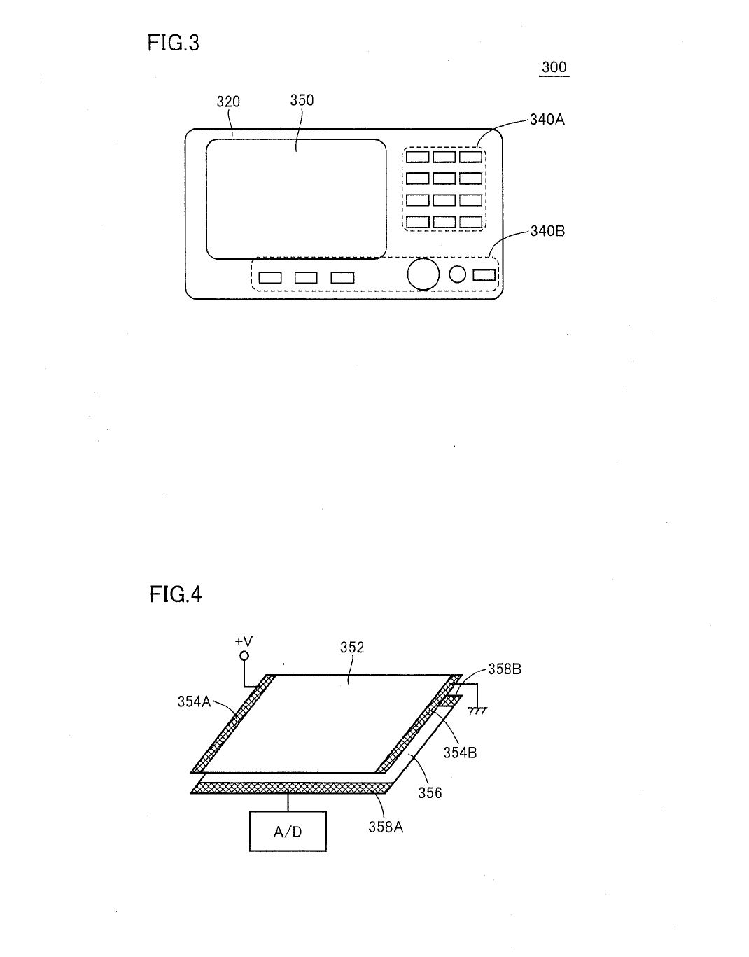

An example of the external appearance of operation panel 300 according to the present embodiment will then be described with reference to FIG. 3.

Referring to FIG. 3, a touch panel 350 is attached to display 320 on operation panel 300 for the user to execute display, setting and the like of various modes. Furthermore, operation keys 340 (operation key groups 340A and 340B) include, for example, a start key for starting the copying/scanning operation and the like, a clear key for clearing the input numerical values, a stop key for giving an instruction to stop the copying/scanning operation, and a reset key for canceling the mode and the job that have been set.

The configuration of touch panel 350 attached to display 320 on operation panel 300 according to the present embodiment will then be described with reference to FIG. 4.

Referring to FIG. 4, touch panel 350 is configured such that a film substrate 352 and a glass substrate 356 are overlaid one on top of the other and in parallel to each other, in which a transparent conductive film made of indium tin oxide or the like is formed on each of the facing surfaces of film substrate 352 and glass substrate 356. Film substrate 352 and glass substrate 356, which are normally separated from each other at a prescribed distance, are brought into contact with each other and into conduction by pressing by a finger or the like. Furthermore, in order to prevent these substrates from being erroneously brought into contact with each other due to deflection of the film caused by external factors, a spacer (not shown) is provided on glass substrate 356 on the side opposite to film substrate 352.

The method of detecting an input to touch panel 350 from the user will then be described.

Film substrate 352 is provided at its both ends in the lateral direction with X electrodes 354A and 354B while glass substrate 356 is provided at its both ends in the vertical direction with Y electrodes 358A and 358B. The X coordinate is detected as described below. Specifically, when a prescribed voltage V is applied to X electrode 354A and X electrode 354B is connected to ground, the resistance in the transparent conductive film causes a potential gradient to be generated in the X direction of film substrate 352. Accordingly, when the potential at the contact point is detected by an A/D converter through glass substrate 356, the X coordinate at the contact point can be detected by partial pressure. Similarly, a prescribed voltage is applied to Y electrodes 358A and 358B by a changeover switch (not shown), so that the Y coordinate can also be detected.

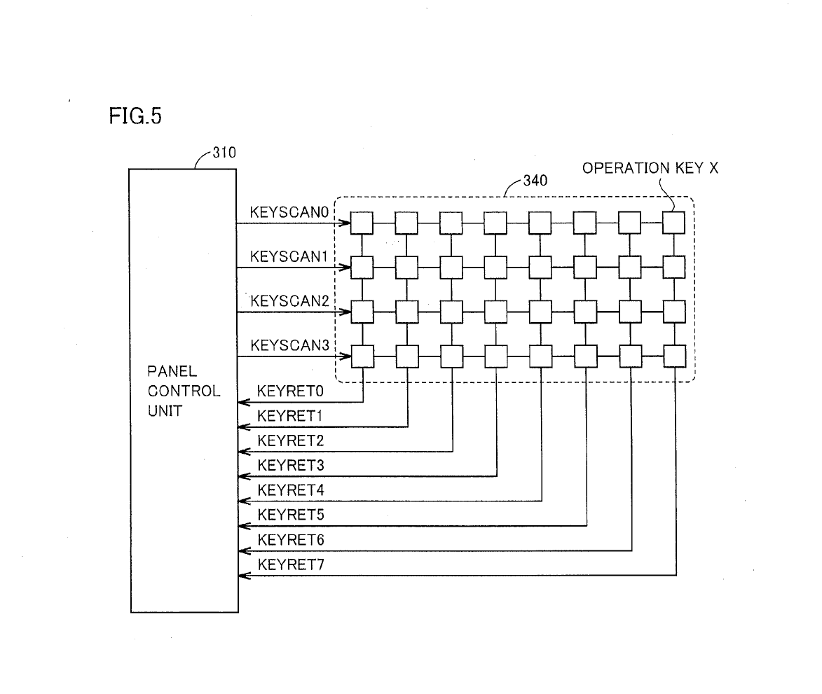

Then, an explanation will be given with reference to FIG. 5 with regard to an example of the schematic configuration of the detection unit corresponding to operation keys 340 on operation panel 300 according to the present embodiment.

Referring to FIG. 5, the detection unit in operation keys 340 consists, for example, of a matrix circuit having interconnections formed in a matrix of four columns by eight rows and an operation key located at each intersection of the interconnections; and a panel control unit 310 having four output ports connecting to interconnections, respectively, in the row direction of the matrix circuit and eight input ports connecting to intersections, respectively, in the column direction of the matrix circuit. Scanning signals (KEYSCAN 0 to 3) are sequentially output from the output ports, respectively. Then, by reading the voltage of the detection signal input into each of the corresponding input ports, it becomes possible to detect which operation key 340 has been pressed. For example, in the case where the voltage of a scanning signal KEYSCAN0 is in a High state, the user presses operation key X, which causes the voltage of a detection signal KEYRET7 corresponding to operation key X to be brought into a Low state and causes the voltage of each of detection signals KEYRET0 to 6 to be brought into a High state. Accordingly, it can be detected that the user has pressed operation key X.

<Operation Mode>

Then, the operation mode of image forming apparatus 1 according to the present embodiment will be described.

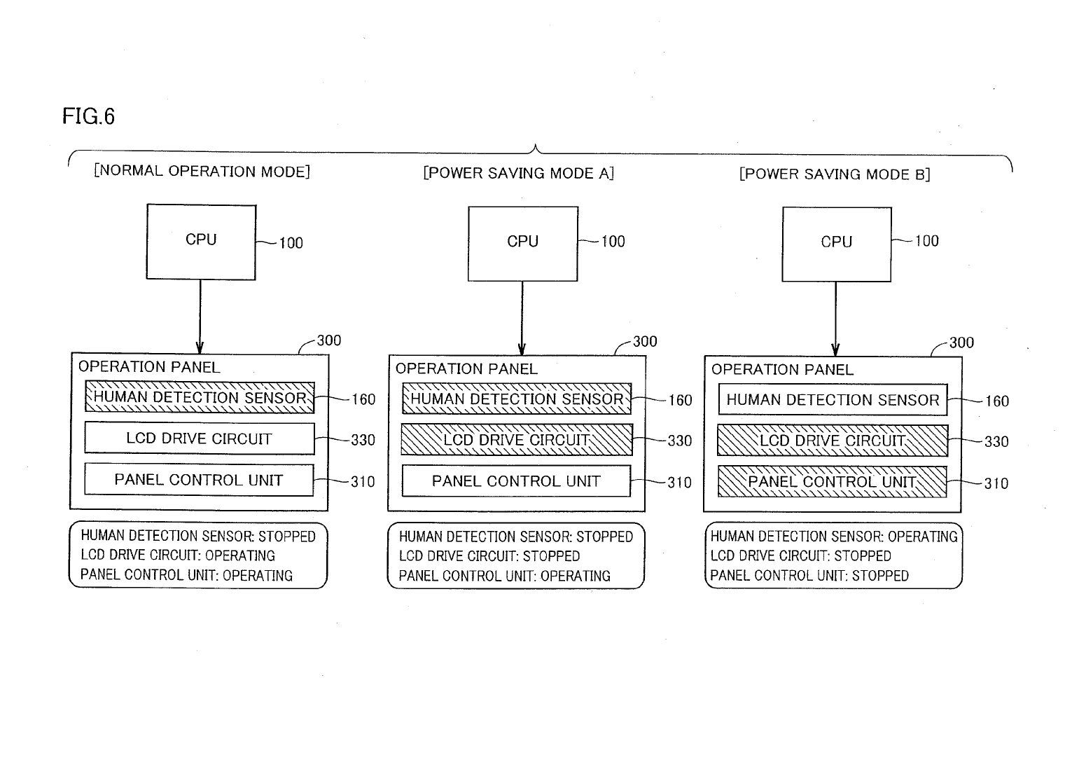

Referring to FIG. 6, an explanation will be given with regard to the details of power control in each of the normal mode and the power saving mode in operation panel 300 according to the present embodiment.

First, the details of power control in the normal mode will be hereinafter described.

In the normal mode, CPU 100 instructs power supply control unit 150 to stop power supply to human detection sensor 160 disposed in operation panel 300 and to supply electric power to units other than human detection sensor 160. This aims to achieve reduction in power consumption of image forming apparatus 1 since, in the normal mode, the function of image forming apparatus 1 can be executed by the user operating operation panel 300 while it is less necessary to detect the user by human detection sensor 160. In this case, since electric power is supplied to panel control unit 310, image forming apparatus 1 can detect the input from the user to operation key 340 and touch panel 350. In addition, since electric power is supplied also to LCD drive circuit 330, the user can visually confirm various pieces of information through display 320.

Then, the details of power control in a power saving mode A will be hereinafter described.

In power saving mode A, CPU 100 instructs power supply control unit 150 to stop power supply to human detection sensor 160 and LCD drive circuit 330 disposed in operation panel 300 and to supply electric power to panel control unit 310. This aims to stop power supply to LCD drive circuit 330 requiring relatively high power consumption in the normal mode since power saving mode A is used in the stage shifting between the normal mode and a power saving mode 13 described below which is a relatively lower power consumption mode. In this case, since electric power is supplied to panel control unit 310, image forming apparatus 1 can detect the input to operation key 340 and touch panel 350 from the user, Upon detection of the input, CPU 100 causes image forming apparatus 1 to shift to the normal mode.

Then, the details of power control in power saving mode B will be hereinafter described.

In power saving mode B, CPU 100 instructs power supply control unit 150 to stop power supply to panel control unit 310 and LCD drive circuit 330 disposed in operation panel 300 and to supply electric power to human detection sensor 160. This aims to achieve further reduction in power consumption of image forming apparatus 1. In this case, since electric power is not supplied to panel control unit 310, the input from the user to operation key 340 and touch panel 350 is not detected. However, since electric power is supplied to human detection sensor 160, the user can be detected within a prescribed detection region. Therefore, when human detection sensor 160 detects the user, CPU 100 causes image forming apparatus 1 to shift to the normal mode.

Then, the processing procedure of shifting the operation mode of image forming apparatus 1 will be hereinafter described.

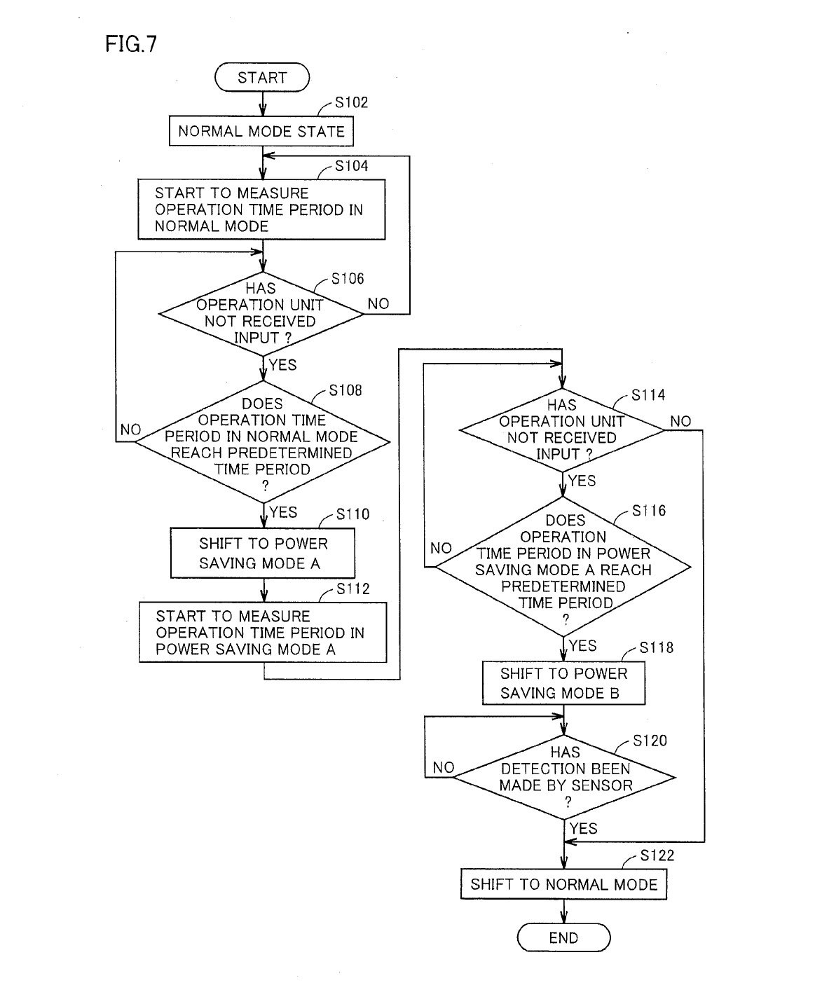

The processing procedure of shifting the operation mode of image forming apparatus 1 according to the present embodiment will be described with reference to FIG. 7.

First, in the normal mode (step S102), in order to measure the time period of the state where image forming apparatus 1 is operating in the normal mode, CPU 100 instructs timer 126 to start to measure the time period of the normal mode (step S104).

Then, operation panel 300 determines based on the detection result in panel control unit 310 whether or not the input instruction from the user has been received (step S106). When operation panel 300 determines that the input instruction from the user has been received (NO in step S106), the process is returned to step S104, in which CPU 100 instructs timer 126 to again measure the time period of the operation in the normal mode from the beginning. On the other hand, when operation panel 300 determines that the input instruction from the user has not been received (YES in step S106), CPU 100 instructs timer 126 to continue to measure the operation time period in the normal mode.

Then, CPU 100 determines whether or not the operation time period in the normal mode that is being measured by timer 126 reaches a predetermined time period (step S108). When CPU 100 determines that the operation time period in the normal mode does not reach the predetermined time period (NO in step S108), the process from step S106 is repeated. On the other hand, when determining that the operation time period in the normal mode reaches the predetermined time period (YES in step S108), CPU 100 causes image forming apparatus 1 to shift, from the normal mode to power saving mode A (step S110). Specifically, CPU 100 instructs power supply control unit 150 to perform power control for power saving mode A as described above.

Then, in order to measure the time period during which image forming apparatus 1 is operating in power saving mode A, CPU 100 instructs timer 126 to start to measure the operation time period in power saving mode A (step S112).

Then, operation panel 300 determines based on the detection result from panel control unit 310 whether or not the input instruction from the user has been received (step S114). When operation panel 300 determines that the input instruction from the user has been received (NO in step S114), CPU 100 causes image forming apparatus 1 to shift from power saving mode A to the normal mode (step S122), and then, ends the process. Specifically, CPU 100 instructs power supply control unit 150 to perform power control for the normal mode as described above. On the other hand, when operation panel 300 determines that the instruction from the user has not been received (YES in step S114), CPU 100 instructs timer 126 to continue to measure the operation time period in power saving mode A.

Then, CPU 100 determines whether or not the operation time period in power saving mode A that is being measured by timer 126 reaches a predetermined time period (step S116). When CPU 100 determines that the operation time period in power saving mode A does not reach the predetermined time period (NO in step S116), the process from step S114 is repeated. On the other hand, when determining that the operation time period in power saving mode A reaches the predetermined time period (YES in step S116), CPU 100 causes image forming apparatus 1 to shift from power saving mode A to power saving mode B (step S118). Specifically, CPU 100 instructs power supply control unit 150 to perform power control for power saving mode B as described above.

Then, CPU 100 determines based on the detection result of human detection sensor 160 whether or not a human body has been detected (step S120). When determining that the human body has not been detected (NO in step S120), CPU 100 maintains the state in step S120 to maintain the state in power saving mode B. On the other hand, when determining that the human body has been detected (YES in step S120), CPU 100 causes image forming apparatus 1 to shift from power saving mode B to the normal mode (step S122), and then, ends the process.

(Outline of Human Detection Sensor)

Then, the outline of human detection sensor 160 will be hereinafter described.

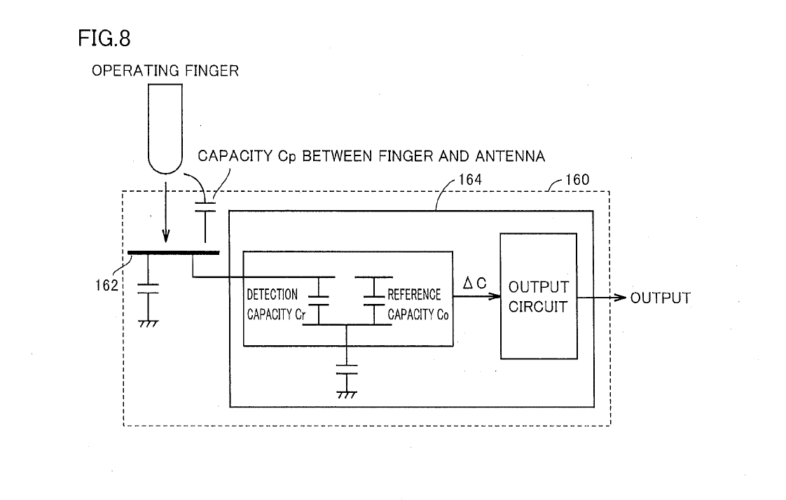

The outline of the configuration of human detection sensor 160 according to the present embodiment will be described with reference to FIG. 8.

Referring to FIG. 8, human detection sensor 160, which is a capacitance-type sensor, is provided at a part of its circuit with a detection electrode (antenna 162), to convert, into an electrical signal, the change in the capacitance of the electrode caused by approach of an object to antenna 162, thereby detecting that the human body is approaching. Briefly, human detection sensor 160, which is provided therein with detection capacity Cr and reference capacity Co, compares detection capacity Cr and reference capacity Co to detect a capacity change AC. For example, when the operating finger of the user approaches antenna 162, capacity Cp between the operating finger and antenna 162 is increased. Accordingly, capacity (Cp+Cr) and reference capacity Co are compared with each other to detect AC. The capacity change of the detected AC causes the oscillation circuit (not shown) within the sensor to oscillate, thereby increasing the current flowing through the circuit. Accordingly, when the predetermined current setting value is exceeded, the output circuit outputs a detection signal to CPU 100. CPU 100 determines based on this detection signal whether or not the human body has been detected.

(Arrangement Position of Human Detection Sensor)

Then, the arrangement position of antenna 162 in human detection sensor 160 will be hereinafter described.

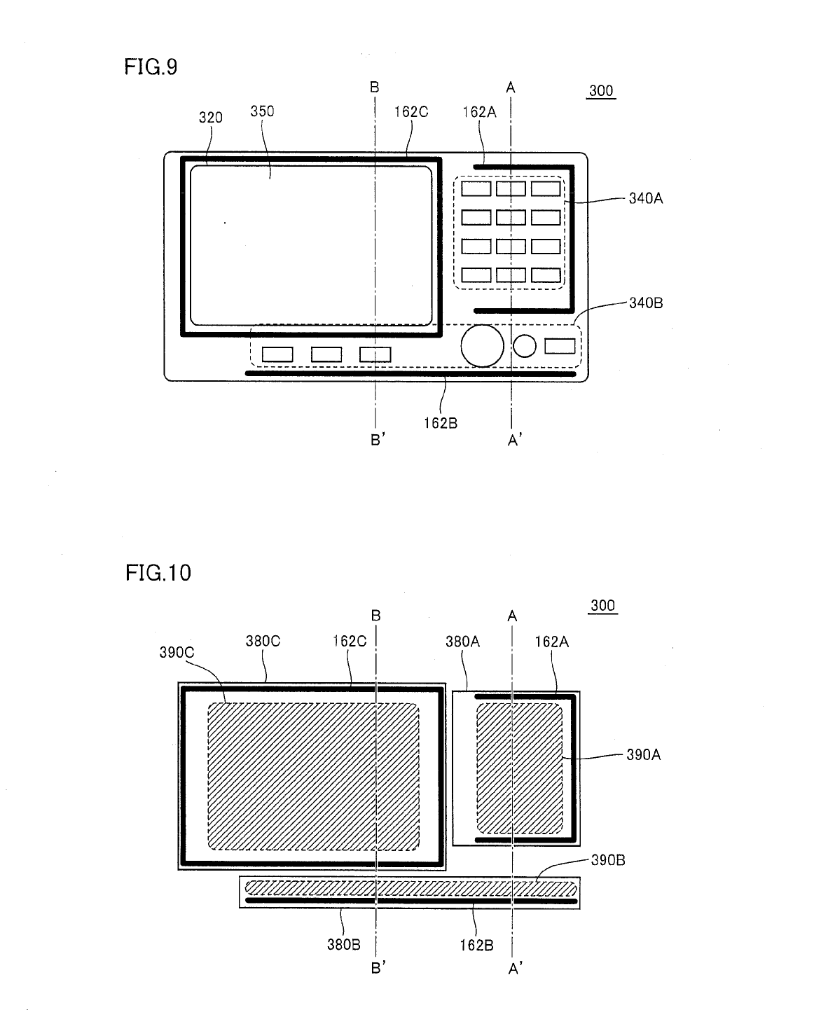

An example of the arrangement position of antenna 162 corresponding to human detection sensor 160 according to the present embodiment will then be described with reference to FIG. 9. It is to be noted that the arrangement position of antenna 162 corresponding to human detection sensor 160 in FIG. 6 is not limited thereto, but may be set in various arrangement positions depending on the user's usage.

Referring to FIG. 9, operation panel 300 includes operation keys 340 (operation key groups 340A and 340B), touch panel 350 attached to display 320, and antennas 162A to 162C corresponding to human detection sensors 160A to 160C.

Antenna 162A is disposed so as to surround the sides of operation key group 340A in a U-shape except for one side thereof located near display 320. Human detection sensor 160A corresponding to antenna 162A can detect the user who is going to press operation key group 340A. It is to be noted that the arrangement pattern is not limited thereto. For example, antenna 162A may surround all sides of operation key group 340A.

Antenna 162B is disposed on the lower side so as to extend along operation key group 340B. Human detection sensor 160B corresponding to antenna 162B can detect the user who is going to press operation key group 340B. It is to be noted that the arrangement pattern is not limited thereto. For example, antenna 162B may surround all sides of operation key group 340B.

Antenna 162C is disposed so as to surround the outer periphery of display 320 and capable of detecting the user who is going to press touch panel 350. It is to be noted that the arrangement pattern is not limited thereto. For example, the antenna may be disposed in a U-shape or in an L-shape so as to extend along the outer periphery.

Then, the arrangement position of antenna 162 will be hereinafter described in greater detail.

An explanation will be given with reference to FIG. 10 with regard to the positional relationship between antenna 162 and a detection unit 390 in operation key 340 and touch panel 350 disposed on a printed circuit board 380 (a printed circuit board 380A, 380B and 380C) of operation panel 300 according to the present embodiment.

Referring to FIG. 10, antenna 162A and a detection unit 390A are disposed in a printed circuit board 380A. Antenna 162B and a detection unit 390B are disposed in a printed circuit board 380B. Antenna 162C and a detection unit 390C are disposed in a printed circuit board 380C. In addition, antennas 162A to 162C are disposed to extend along the outer periphery of printed circuit board 380 so as not to physically interfere with detection units 390A to 390C.

Detection units 390A and 390B serve to detect the user's input to operation key groups 340A and 340B, respectively, for example, by the detection method described with reference to FIG. 5.

Detection unit 390C serves to detect the user's input to touch panel 350, for example, by the detection method described with reference to FIG. 4.

Then, the cross-section structure of operation panel 300 will be described.

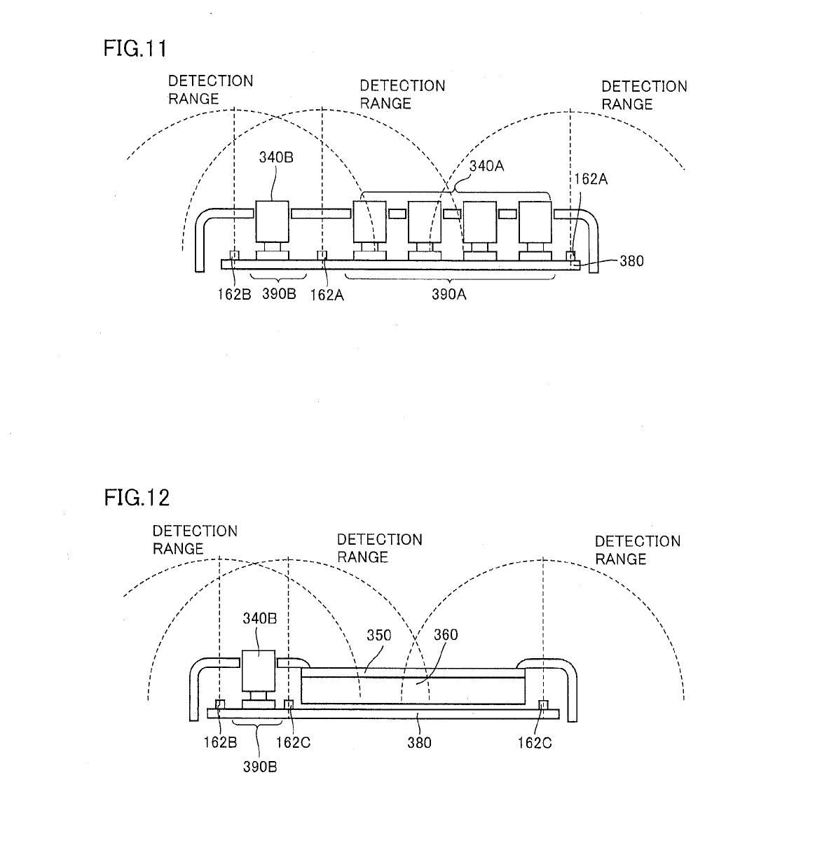

The schematic cross-section structure of operation panel 300 taken along a line A-A′ in FIGS. 9 and 10 will be hereinafter described with reference to FIG. 11.

Referring to FIGS. 10 and 11, antenna 162A is disposed so as not to physically interfere with detection unit 390A of operation key group 340A that is disposed on printed circuit board 380A. Furthermore, antenna 162B is similarly disposed so as not to physically interfere with detection unit 390B of operation key group 340B that is disposed on printed circuit board 380B. In addition, the detection range of human detection sensor 160A corresponding to antenna 162A is set such that the user who is going to press operation key group 340A can be detected while the detection range of human detection sensor 160B corresponding to antenna 162B is set such that the user who is going to press operation key group 340B can be detected.

The schematic cross-section structure of operation panel 300 taken along a line B-B′ in FIGS. 9 and 10 will be hereinafter described with reference to FIG. 12.

Referring to FIGS. 10 and 12, an LCD module 360 is provided below touch panel 350 (in the direction of printed circuit board 380C) while printed circuit board 380C is provided below LCD module 360. Antenna 162B and antenna 162C are disposed so as not to physically interfere with LCD module 360 and detection unit 390B that is disposed on printed circuit board 380B. In addition, the detection range of human detection sensor 160B corresponding to antenna 162B is set such that the user who is going to press operation key group 340B can be detected. Furthermore, the detection range of human detection sensor 160C corresponding to antenna 162C is similarly set such that the user who is going to press touch panel 350 can be detected.

As described above, antenna 162 can be disposed utilizing the existing space in printed circuit board 380 in operation panel 300 while the human body can be detected by human detection sensor 160. Furthermore, as described above, in the power saving mode, power supply control unit 150 supplies electric power to human detection sensor 160, but not to panel control unit 310. Consequently, the function of panel control unit 310, that is, the function of detection unit 390, becomes unavailable. Therefore, no influence is exerted upon antenna 162 of human detection sensor 160 by the noise produced by a change in the signal caused when the function of detection unit 390 is set available. Accordingly, even if antenna 162 is disposed adjacent to detection unit 390, the detection accuracy of human detection sensor 160 can be maintained. Furthermore, since antenna 162 can be disposed adjacent to detection unit 390, image forming apparatus 1 can be reduced in size without having to employ a substrate dedicated to the sensor.

### Other Embodiments

Although an explanation has been given in the above description with regard to the example in which antenna 162 of human detection sensor 160 is disposed on printed circuit board 380, an antenna in a wire shape may be provided in the housing of operation panel 300. In this case, holding means for stabilized holding of the housing may be separately provided.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An image forming apparatus operating in modes including a normal mode and a power saving mode less in power consumption than said normal mode, said image forming apparatus comprising:
an operation unit for receiving an instruction from a user, said operation unit having an operation region into which a prescribed instruction from the user is input;
a first detection unit disposed corresponding to said operation region for detecting an input from the user into said operation region in said normal mode; and
a second detection unit for detecting a human body located near said operation region in said power saving mode,
said second detection unit being disposed on a substrate on which said first detection unit is disposed.

2. The image forming apparatus according to claim 1, wherein
said second detection unit includes an antenna unit for detecting a change in capacitance of an electrode caused by approach of an object, and
said antenna unit is disposed on the substrate on which said first detection unit is disposed.

3. The image forming apparatus according to claim 2, wherein said antenna unit is disposed along an outer periphery of said substrate.

4. The image forming apparatus according to claim 1, further comprising a power supply control unit for supplying electric power to said second detection unit but not to said first detection unit in the power saving mode.

5. The image forming apparatus according to claim 1, wherein a detection region in said second detection unit is defined in a range including said operation region.

6. The image forming apparatus according to claim 1, wherein said second detection unit detects the human body by detecting a change in capacitance between a detection electrode and the human body.
